(19) United States
(12) Patent Application Publication
(10) Pub. No.: US 2014/0361889 A1
(43) Pub. Date: Dec. 11, 2014

(54) Child Occupancy Monitoring System for a Vehicle Seat

(71) Applicants: Billy Russell Wall, II, Arrington, TN (US); Ramin Hanai, Nashville, TN (US)

(72) Inventors: Billy Russell Wall, II, Arrington, TN (US); Ramin Hanai, Nashville, TN (US)

(21) Appl. No.: 14/090,421

(22) Filed: Nov. 26, 2013

Related U.S. Application Data
(60) Provisional application No. 61/730,037, filed on Nov. 26, 2012.

(51) Int. Cl. G08B 21/02

(52) U.S. Cl. CPC G08B 21/0233
USPC 340/539.11

(57) ABSTRACT

The electronic system for monitoring the occupancy of a vehicle seat to alert of an abandoned child includes a pressure sensing pad, that is placed atop a vehicle seat under an infant or child safety car seat and control module that interacts with a wireless device or FOB. When the pressure pad senses the weight of an infant or child on the vehicle seat, but the control module fails to detect the physical presence of the FOB within a predetermined range, the control module signals an alarm.

This application claims priority from co-pending U.S. Provisional Patent Application Ser. No. 61/730,037 filed on Nov. 26, 2012, entitled “Child Occupancy Monitoring System for a Vehicle Seat.”

This invention relates to an electrical system for monitoring the occupancy of a vehicle seat for alerting of an abandoned child.

### BACKGROUND AND SUMMARY OF THE INVENTION

Leaving an infant and toddler in an automobile is dangerous and has resulted in several fatalities every year. The present invention provides an electronic system for monitoring the occupancy of a vehicle seat to alert of an abandoned child. In one embodiment, the child occupancy monitoring system (COMS) of this invention includes a pressure sensing pad, that is placed atop a vehicle seat under an infant or child safety car seat and control module that interacts with a wireless hand held device, such as the vehicle's ignition FOB. When the pressure pad senses the weight of an infant or child on the vehicle seat, but the control module fails to detect the physical presence of the FOB within a predetermined range, the control module immediately signals an alarm. In various embodiments, the control module may use proximity sensors or various wireless communication technologies to detect the proximity of the ignition FOB. In another embodiment, the COMS includes a two piece buckle assembly mountable to the existing belt straps of child safety seat, which communicates with the control module to sound an alarm when the FOB is outside a predetermined range to alert of an abandoned child. The buckle assembly has two connector parts that when coupled together generates a wireless “occupancy” signal received by the control module. The control module constantly monitors both the physical proximity of FOB and the wireless occupancy signal from the buckle assembly. Should the FOB move outside a predetermined range from the control module when the occupancy signal from buckle assembly is being received, the control module activates a visual and/or audible alarm alerting the FOB holder or passers by that the child is still secured in the safety seat.

These and other advantages of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a simplified perspective view of a vehicle and an embodiment of the Child Occupancy Monitoring System (COMS) of this invention showing an alert condition;

FIG. 2 is another simplified perspective view of a vehicle and the Child Occupancy Monitoring System (COMS) of FIG. 1 showing a normal condition;

FIG. 3 is a simplified perspective view of the Child Occupancy Monitoring System (COMS) of FIG. 1;

FIG. 4 is a simplified exploded view of the vehicle's rear seat and the Child Occupancy Monitoring System (COMS) of FIG. 1;

FIG. 5 is a simplified top view of a vehicle and an embodiment of the Child Occupancy Monitoring System (COMS) of FIG. 1;

FIG. 6 is a simplified perspective view of another embodiment of the Child Occupancy Monitoring System (COMS); and

FIG. 7 is a simplified exploded view of the vehicle's rear seat and the Child Occupancy Monitoring System (COMS) of FIG. 6;

FIG. 8 is a simplified perspective view of a vehicle and a third embodiment of the Child Occupancy Monitoring System (COMS) of this invention showing an alert condition;

FIG. 9 is a perspective view of the child safety seat of FIG. 8 showing the buckle assembly used by the Child Occupancy Monitoring System (COMS) of FIG. 8;

FIG. 10 is a simplified perspective view of the Child Occupancy Monitoring System (COMS) of FIG. 8;

FIG. 11 is a perspective view of the buckle assembly used by the Child Occupancy Monitoring System (COMS) of FIG. 8 show in an unbuckled state; and

FIG. 12 is a perspective view of the buckle assembly used by the Child Occupancy Monitoring System (COMS) of FIG. 8 show in a buckled state.

### DESCRIPTION OF THE PREFERRED EMBODIMENT

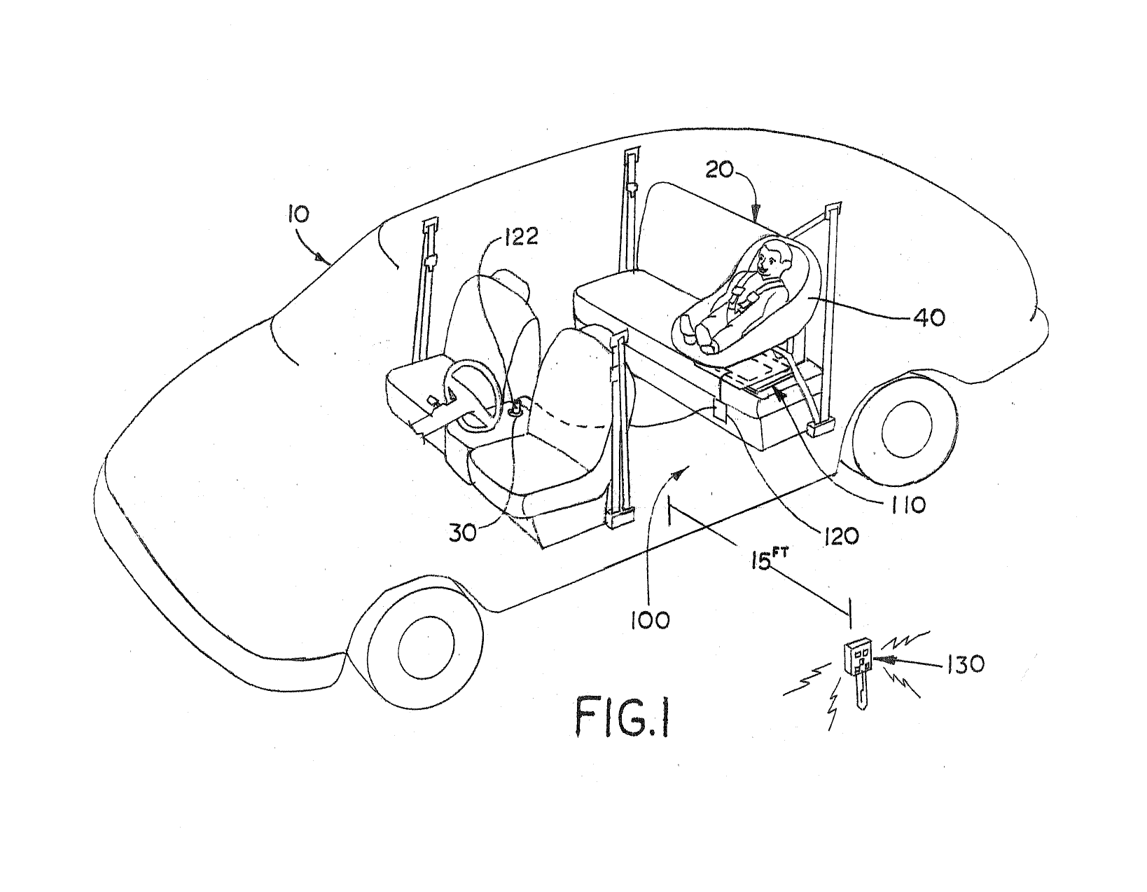

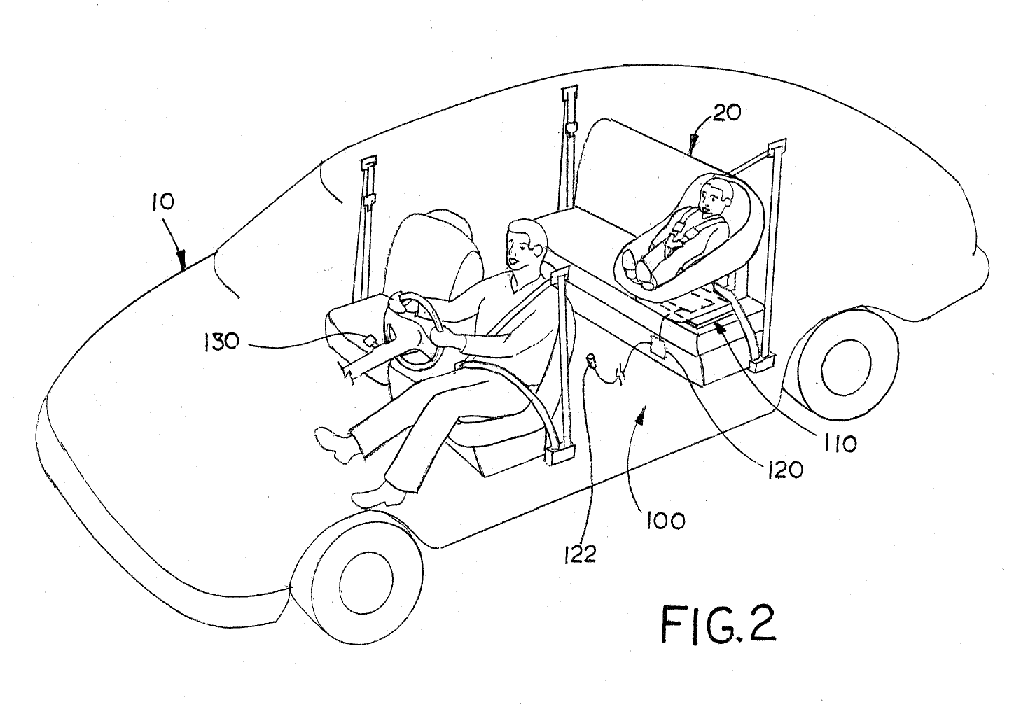

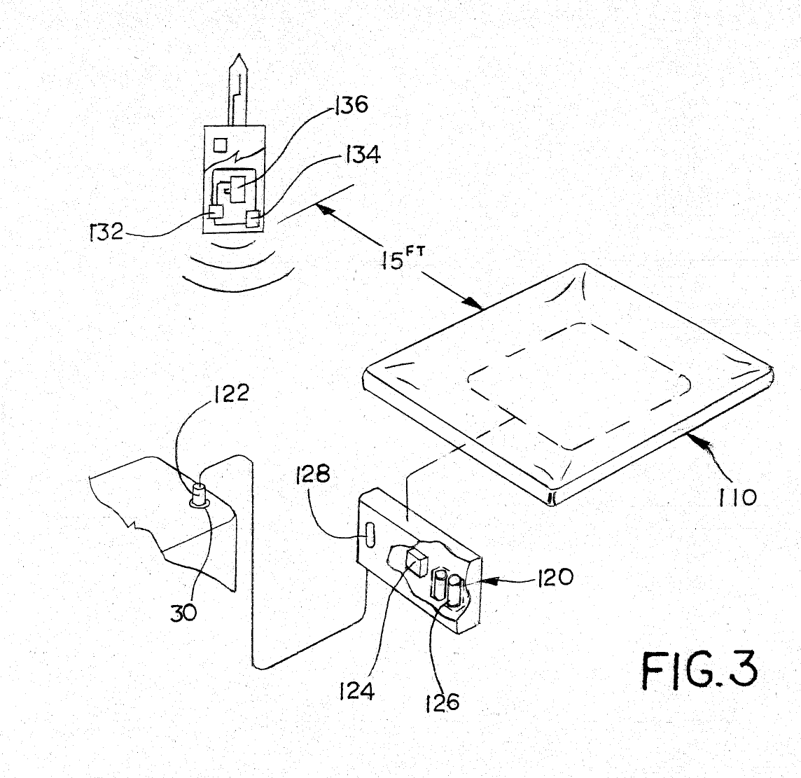

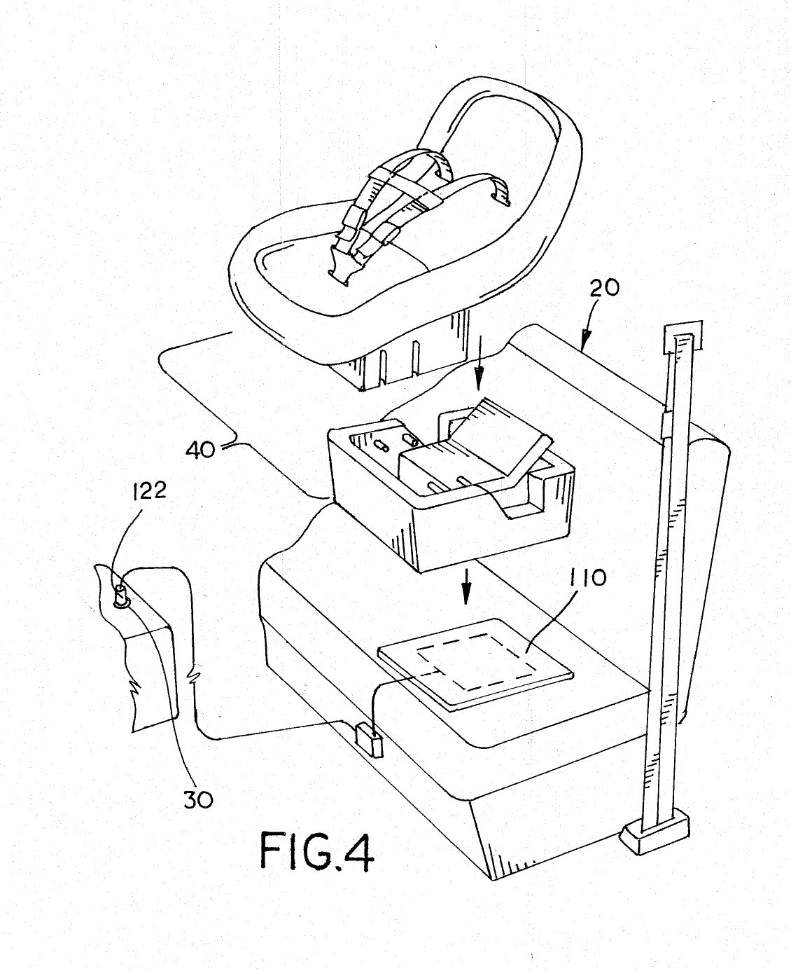

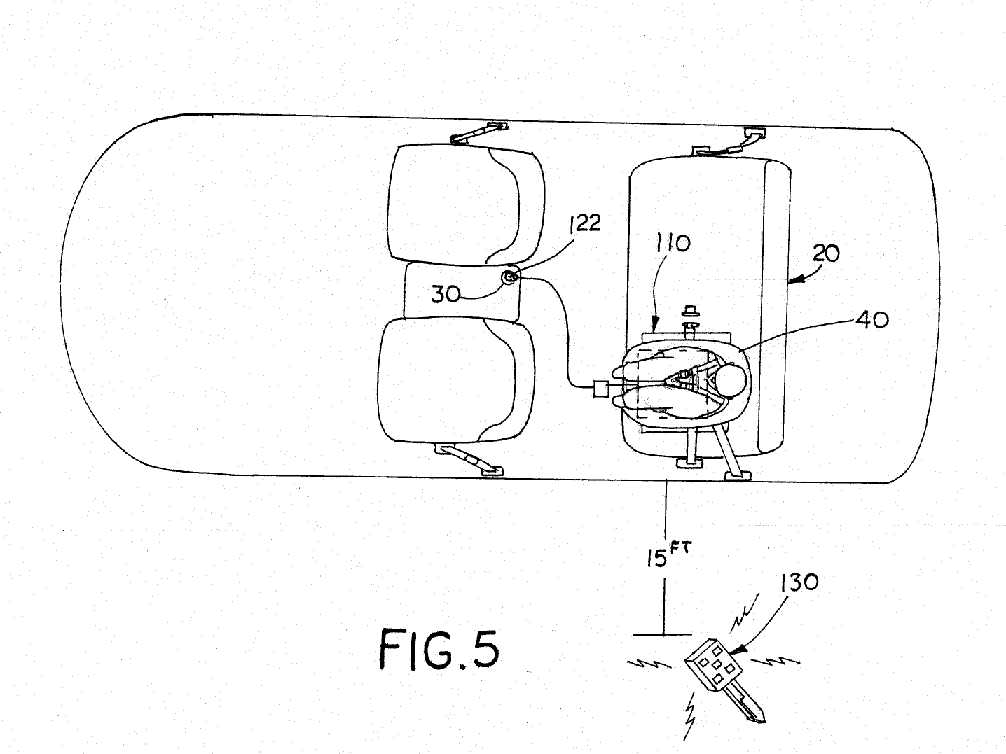

Referring now to the drawings and schematics, FIGS. 1-5 illustrate a typical vehicle 10 and an embodiment of the child occupancy monitoring system (COMS) of this invention, which is generally designated as reference numeral 100. COMS 100 is designed to audibly and visually alert a driver when an infant or child is inadverently left in a child safety seat in a vehicle. In this embodiment, COMS 100 is intended as an after market accessory. COMS 100 includes a pressure sensitive seat pad 110, a control module 120, and a wireless FOB 130.

FOB 130 is a hand held device that wirelessly communicates with control module 120. In certain embodiments FOB 130 is a separate dedicated handheld device specifically used with COMS 100. In other embodiments, a vehicle's wireless ignition or keyless entry FOB may be adapted for use with COMS 100. FOB 130 has its own internal circuitry, which includes a power supply, typically an internal battery (not shown), an audible alarm 136 and an optional visual indicator , such as an LED light (not shown), and corresponding communication/detection circuitry connected to main logic control chip 132 of control module 120.

Pressure pad 110 is placed atop a vehicle seat 20 under a conventional child safety seat 30. Pressure pad 110 generates an electrical signal when the weight on the pad exceeds a predetermine limit, which approximates the minimum weight of an infant or child seated atop the vehicle seat. Ideally, pressure pad 110 is adapted to selectively set and adjust the weight limit at which the pad actuates in order to accommodate weight difference in various child safety seats. Pressure pad 110 may take a variety of forms, but generally is constructed of two layers of flexible conductive material, which form a complete electrical circuit when pressed together under a certain force. Pressure pad 110 is generally flexible and shaped to conform to the contour of vehicle seat 20.

Control module 120 provides the logic circuitry for the COMS 100. As shown, control module 120 is powered by the vehicle's own auxiliary DC power supply 30 and an internal backup battery 126. A power adapter 122 connects control module 120 to power supply 30. Alternatively, control module 120 may be powered solely by its own internal power supply, such as replaceable or rechargeable batteries. Control module 120 is electrically connected to pressure pad 110 and responsive to the electrical signals from the pad. Control module 120 includes corresponding communication/detection circuitry mated to FOB 130. Control module 120 may also include a visual indicator 128, which may take the form of an LED light or other suitable alarm mechanism. The communication/proximity detection circuitry used by control module 120 and FOB 130 may take a variety of forms. In certain embodiments, FOB 130 and control module 120 may employ proximity sensors 124 and 134, respectively, that activate when the FOB moves outside of a predetermined physical range from the control module.

In operation, control module 120 constantly monitors the presence of FOB 130. When an infant or child is seated within safety seat 40, the weight of the safety seat 40 and the infant or child exceeds the predetermined pressure limit for pressure pad 110, which sends an electrical signal to control module 120. If FOB 130 should move outside a predetermined range from Control module 120 (fifteen feet for example) when a signal from pressure pad 110 indicates the presence of an infant or child in the safety seat 40, both audible alarm 136 in FOB 130 will sound and visual indicator 128 will illuminate. An audible alarm within control module 120 is optional, but generally undesireable because of the potential for frightening the infant or child.

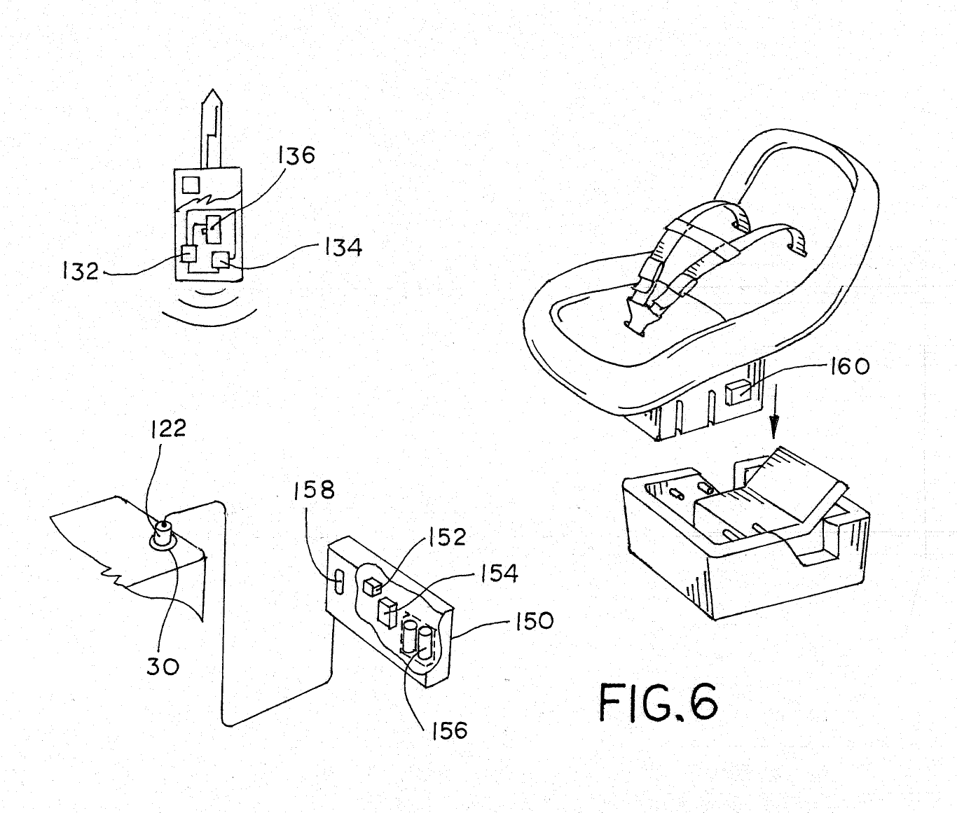

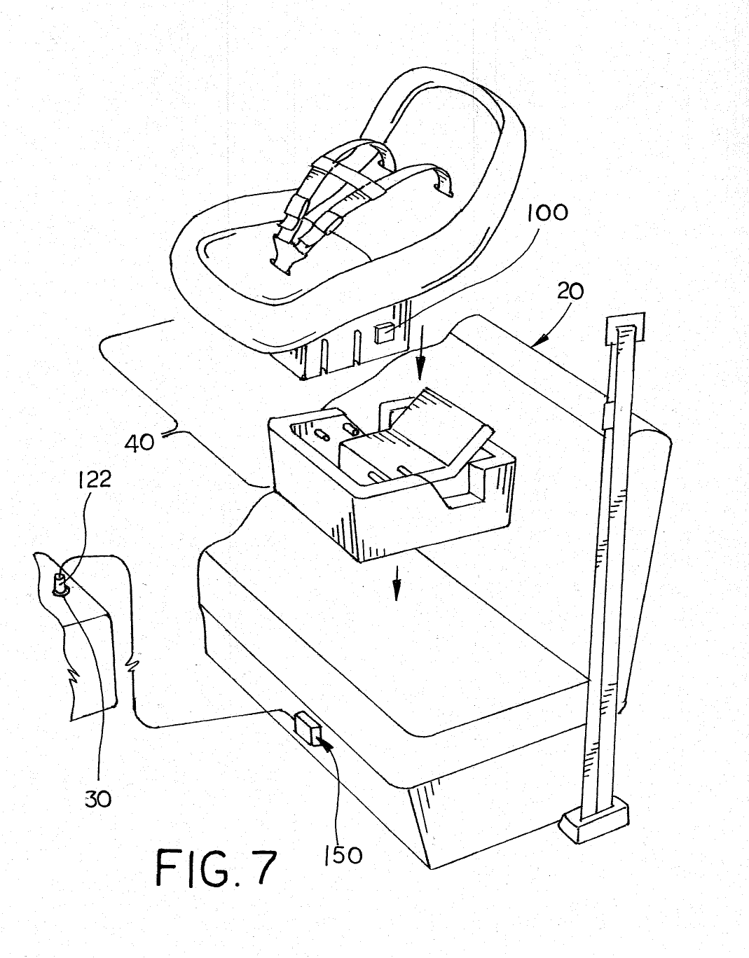

FIGS. 6 and 7 illustrated a second embodiment of the child occupancy monitoring systems (COMS) of this invention, which is designated generally as reference number 140. COMS 140 is similar in functional and operation to COMS 100, except that pressure pad 110 is replaced by a second set of proximity sensors 160 and 162. As shown, proximity sensor 160 is affixed directly to the detachable infant safety seat 40′ using an adhesive or other suitable means. Proximity sensor 162 is incorporated into the communication/proximity detection circuitry of control module 150. When control module 150 detects the presence of safety seat 40′ within a predetermined distance from the control module, alarms again will sound and activate if FOB 170 moves outside its predetermine range from control module 150.

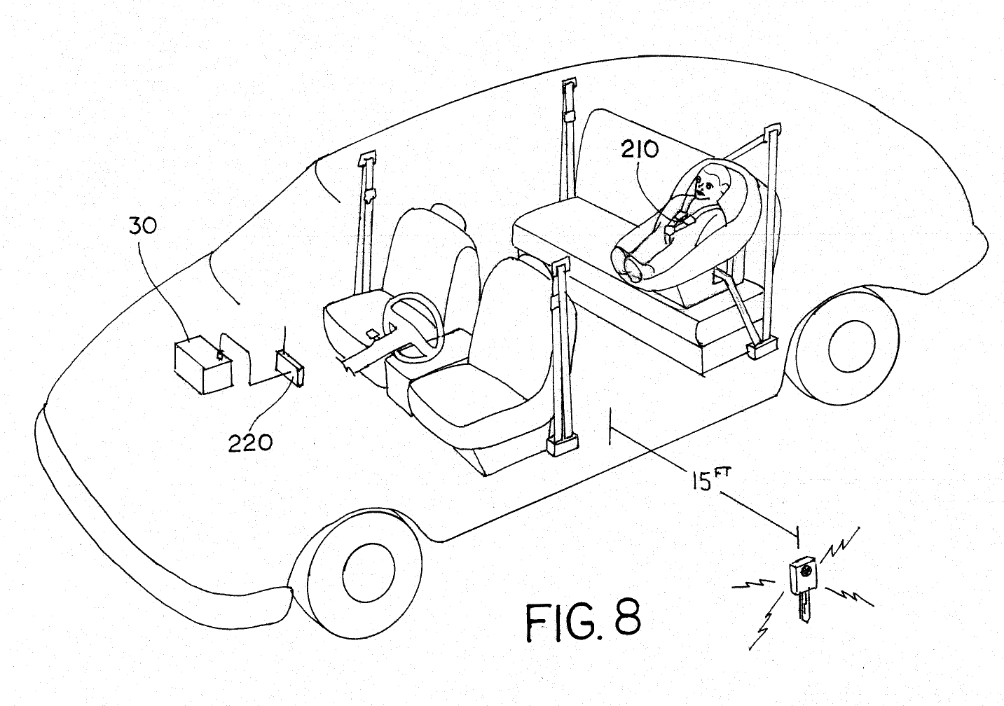

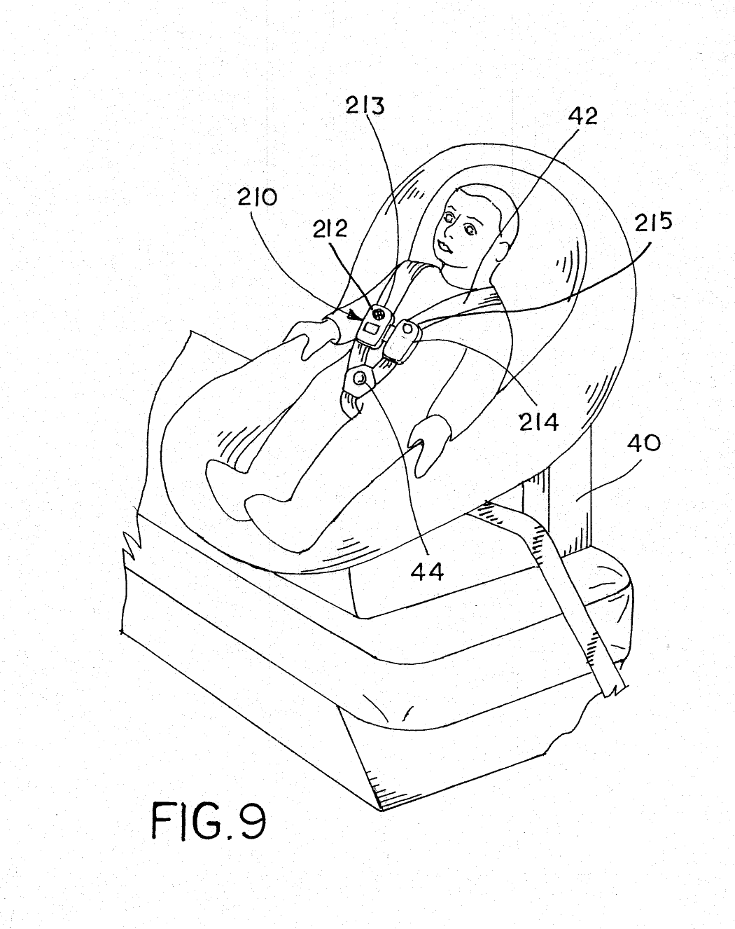

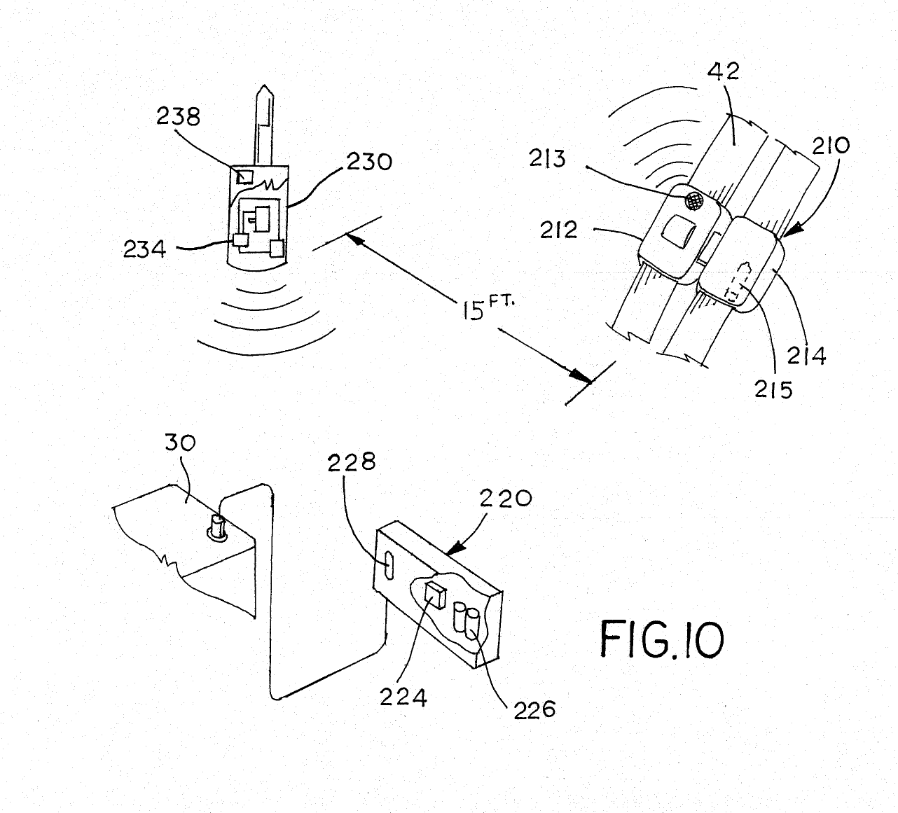

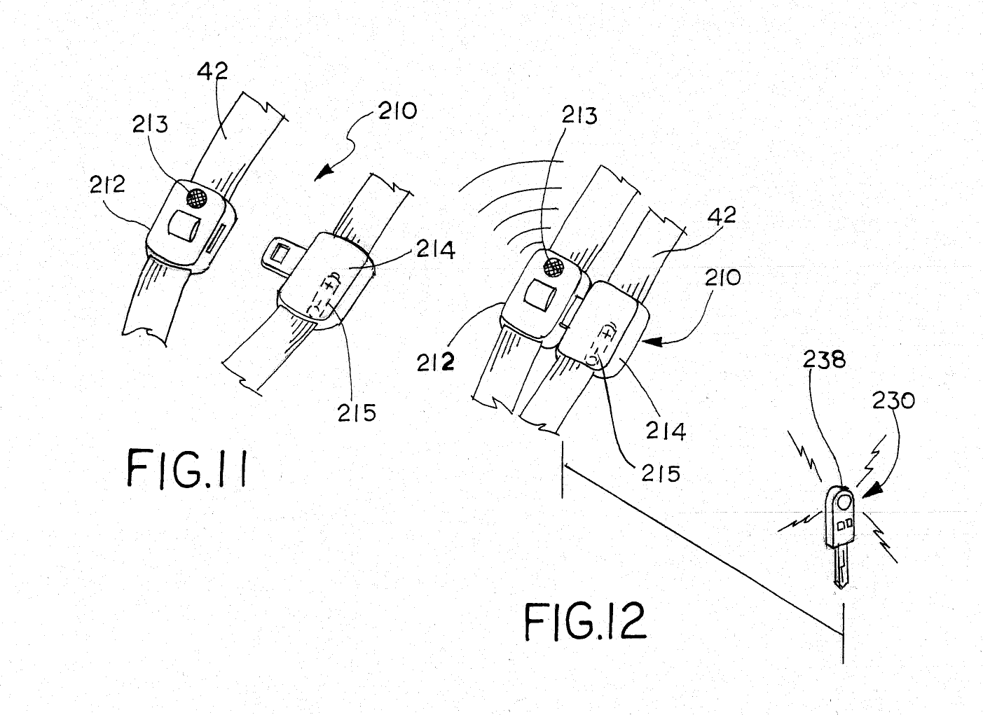

FIGS. 8-12 illustrate a third embodiment of the CMOS of this invention, which is generally designated as reference numeral 200. COMS 200 includes a buckle assembly 210, a control module 120, and a wireless FOB 130. Buckle assembly 210 is intended as an after market accessory that mounts directly to the belt straps of any conventional child safety seat. Buckle assembly 210 has two connector part 212 and 214, which clip to the belt straps 42 of child safety seat 40 above the safety seat buckle 44. Connector part 212 houses an electronic transmitter 213 and connector part 214 houses a battery power supply 215. When connector parts are coupled together, an electrical connection is established, which powers up transmitter 215 that sends a wireless signal to control module 220. Control module 220 of COMS 200 is identical in design and function to the control module used in COMS 100 described above and provides the logic circuitry for the COMS 200. Control unit 220 is powered by the vehicle's battery 30, but may have its own independent power supply 226. Similarly, FOB 230 is identical in design and function as FOB 130 of COMS 100, as described above. The electrical circuitry of FOB 230 includes a visible and audiable alarm 238. The circuitry of both FOB 130 and control module 120 employ mated proximity sensors 224 and 234, respectively, that activate when the FOB moves outside of a predetermined physical range from the control module. Again, control module 220 constantly monitors the proximity of FOB 230 and the wireless signal from buckle assembly 210. The constant wireless signal from buckle assembly 210 generated when connector parts 212 and 214 are coupled together indicates the presence of a child secured within safety seat 40. Again, should FOB 230 move outside a predetermined range from control module 220 when a signal from buckle assembly 210 is being received, control module 220 will activate a visual and/or audible alarm 228 alerting the FOB holder or passers by that the child is still secured in the safety seat.

In other embodiments, the control module, pressure pad and/or proximity sensors of the COMS may be incorporated directly into a vehicle's existing occupancy classification system (OSC) and ignition and keyless entry FOBs. Furthermore, other embodiments of the COMS may employ a variety of communication/detection circuitry and using any suitable wireless communication technology, including but not limited to radio frequency (RF), infrared, WiFi, Blue Tooth®, Wibree®, personal area network under IEEE specification 802.15 or other similar short range communication protocol. For example, an embodiment of the communication/detection circuitry of FOB 130 and control module 120 may incorporate a Wibree chip set to create a personal operating space (POS) within the vicinity of the FOB. Wibree, also called “Baby Bluetooth,” is a low-power wireless local area network (WLAN) technology that facilitates interoperability among mobile devices such as FOB 130 and control module 120. Wibree operates at a range of 5 to 10 meters (about 16.5 to 33 feet) with a data rate of up to 1 megabit per second (Mbps) in the 2.4-GHz radio-frequency (RF) band. The personal operating space is maintained as long as the FOB is within communication range of the control module. If communication between the control module and the FOB is interrupted, because the FOB moves outside the communication range with control module, an alarm in the FOB would sound alerting of the continued occupancy of the vehicle seat.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

We claim:

1: In a vehicle having a seat and safety restraints, an electrical system for externally indicating the occupancy status of the seat comprising:
a wireless device adapted to by carried by a user;
an alarm;
a pressure sensitive pad adapted to overly the vehicle seat for detecting the weight of an infant or child;
control unit operatively connected to the pad for activating the alarm when pressure pad detects the presence of an infant or child seated thereon and the wireless device is physically outside a predetermined range from the control unit.

2: The system of claim 1 wherein the control unit and wireless device each include proximity detection circuitry that generates a signal when the wireless device is outside a predetermined range from the control unit.

3: In a vehicle having a seat and safety restraints, an electrical system for externally indicating the occupancy status of the seat and the status of the safety restraints comprising:
a wireless device adapted to be carried by a user;
an alarm;
a buckle assembly adapted to be mounted to the safety restraints and having a first connector part and a second connector part, the buckle assembly generating a occupancy signal when the first connector part is couple to the second connector part,
a control unit responsive to the occupancy signal from the buckle assembly and the proximity of the wireless device to the control unit for activating the alarm when the wireless device is physically outside a predetermined range from the control unit.

4: The system of claim 3 wherein the first connector part includes a power supply and second connector part includes a transmitter to generating the signal.

5: The system of claim 3 wherein the occupancy signal is a wireless signal received by the control unit.

6: The system of claim 3 wherein the control unit and wireless device each include proximity detection circuitry that generates a signal when the wireless device is outside a predetermined range from the control unit.
